(19) United States
(12) Patent Application Publication
(10) Pub. No.: US 2026/0153591 A1
(43) Pub. Date: Jun. 4, 2026

(54) Omnidirectional Validation of Broadcast Information

(71) Applicant: Sagetech Avionics, Inc., White Salmon, WA (US)

(72) Inventors: Matthew Hamilton, White Salmon, WA (US); Tom Furey, White Salmon, WA (US)

(73) Assignee: Sagetech Avionics, Inc., White Salmon, WA (US)

(21) Appl. No.: 19/457,129

(22) Filed: Jan. 22, 2026

Related U.S. Application Data
(63) Continuation-in-part of application No. 17/973,711, filed on Oct. 26, 2022, now abandoned.
(60) Provisional application No. 63/273,364, filed on Oct. 29, 2021.

(51) Int. Cl. G01S 5/02; G01S 19/48

(52) U.S. Cl. CPC G01S 5/0294; G01S 5/0268; G01S 19/48; G01S 2205/03

(57) ABSTRACT

An electronic device (such as a transponder or an aircraft that includes the transponder) is described. This electronic device may include: two omnidirectional antennas; and one or more integrated circuits (such as one or more radios) that transmit and receive RF signals. During operation, the electronic device may receive, using the omnidirectional antennas, broadcast information associated with a second electronic device (such as a second transponder or a second aircraft that includes the second transponder), where the broadcast information is compatible with a regulation from a government aviation or aviation safety administration (such as the Federal Aviation Administration). Then, the electronic device may validate the broadcast information using one or more of: time difference of arrival at the omnidirectional antennas; Doppler shift; or Doppler spread. Next, the electronic device may determine a track of the second electronic device based at least in part on the broadcast information.

### CROSS REFERENCE TO RELATED APPLICATIONS

This application is a Continuation-in Part of U.S. Non-Provisional application Ser. No. 17/973,711, “Omnidirectional Validation of Transponder Broadcast Information,” filed on Oct. 26, 2022, by Matthew Hamilton, et al., which claims priority under 35 U.S.C. 119(e) to U.S. Provisional Application Ser. No. 63/273,364, “Omnidirectional Validation of Transponder Broadcast Information,” filed on Oct. 29, 2021, by Matthew Hamilton, et al., the contents of both of which are herein incorporated by reference.

### FIELD

The described embodiments relate to detection and avoidance techniques for crewed and uncrewed aircraft. Notably, the described embodiments relate to determining and/or validating an aircraft track using an omnidirectional antenna.

### BACKGROUND

A transponder is an electronic device that transmits a response when it receives a radio-frequency interrogation. In contrast with a transceiver, which transmits and receives using a common carrier frequency, a transponder transmits and receives using different carrier frequencies.

Aircraft are typically required to include transponders to assist in identifying them, e.g., on air traffic control radar. In addition, collision avoidance systems have been developed that use transponder transmissions to detect and avoid aircraft that are at risk of colliding with each other. For example, the Federal Aviation Administration (FAA) in the United States mandated the use of the Traffic Alert and Collision Avoidance System (TCAS), which is a collision avoidance system and air-to-air communication technique for piloted civilian aircraft using transponder messages. Notably, TCAS is an onboard system by which aircraft avoids a potential collision threat by performing a vertical avoidance maneuver, such as climbing or descending.

However, TCAS is not well-suited for helicopters or uncrewed aircraft, such as drones. Currently, unless a professional waiver is granted by the FAA, the absence of a Detect and Avoid (DAA) system (which includes collision avoidance) for drones restricts their use to visual line of sight by the operator or to use in conjunction with a separate visual observer.

In order to address these and other challenges, enhanced collision avoidance systems, such as the Airborne Collision Avoidance System (ACAS) Xu (which is a DAA system), are being developed. ACAS Xu is intended for use by a variety of different types of aircraft, including rotorcraft and uncrewed aircraft. In addition, ACAS Xu may be used to detect and avoid a threat associated with a cooperative or an uncooperative aircraft (such as a drone or other aircraft that is not equipped with a transponder). Notably, ACAS Xu may use an input from a cooperative source, such as an Automatic Dependent Surveillance—Broadcast (ADS-B) message. ADS-B are Global Positioning System (GPS)-based automatic transmissions that are provided periodically.

There are, however, concerns about the reliability of this type of input. Notably, ADS-B transmissions are not encrypted and are based on GPS signals. Consequently, ADS-B messages can be jammed, spoofed or become unavailable.

In principle, a system can perform additional measurements to validate transponder broadcast information, such as ADS-B messages. For example, if a system includes active surveillance capability, measurements (including range, altitude and bearing) can be determined to localize another aircraft and, thus, to verify its track, as specified by the transponder broadcast information from the other aircraft. Note that active surveillance is typically accomplished by a system that includes one or more directional antennas for transmitting to, and receiving signals from, transponder equipped aircraft.

However, in practice, the use of directional antennas increases the size, weight and cost of the overall system. Larger and heavier systems are problematic or prohibitive in many aircraft applications, such as in uncrewed aircraft (e.g., drones), where there are strong constraints on the size and weight of the system components because of installation limitations and performance capabilities.

### SUMMARY

In a first group of embodiments, an electronic device is described. This electronic device includes: an omnidirectional antenna; and one or more integrated circuits (such as one or more radios) that transmit and receive radio-frequency (RF) signals. During operation, the electronic device receives, using the omnidirectional antenna, broadcast information associated with a second electronic device (e.g., a transponder), where the broadcast information is compatible with a regulation from a government aviation or aviation safety administration (such as the Federal Aviation Administration or the European Union Aviation Safety Agency). Then, the electronic device determines a track of the second electronic device based at least in part on the broadcast information.

Note that the track may include one or more of: horizontal location or position, relative range, relative bearing, heading, relative or absolute altitude, and/or relative or absolute speed.

Moreover, determining the track may involve measuring range (such as slant range) to the second electronic device as a function of time. For example, the range to the second electronic device may be measured using time-of-flight measurements by providing an interrogation signal and subsequently receiving an associated response from the second electronic device. In some embodiments, the interrogation signal may be selectively transmitted to the second electronic device with a carrier frequency of 1,030 MHz using mode S interrogation. Alternatively, the interrogation signal may be an all-call interrogation with a carrier frequency of 1,030 MHz that is transmitted to any electronic device in proximity (such as wireless range) of the electronic device, and that results in subsequent responses from any transponders that receive this interrogation signal.

Furthermore, the track may be determined in two dimensions (2D) or three dimensions (3D) when an altitude or vertical position of the electronic device and/or the second electronic device are available. Additionally, in some embodiments, determining the track may involve: performing Doppler measurements of range; and correlating the range to speed and/or velocity of the second electronic device.

Note that the electronic device may include a transponder, and the transmit RF signals and the receive RF signals may use different carrier frequencies. Moreover, the second electronic device may include a second transponder, e.g., in a cooperative aircraft. Alternatively, the second electronic device may include a repeater (e.g., an ADS-R) ground station.

Furthermore, in some embodiments, the electronic device may include an aircraft, such as a crewed or uncrewed aircraft. For example, the electronic device may include an aircraft, such as: an airplane, a helicopter, a glider, a drone, or another type of aircraft.

Additionally, the electronic device may validate or verify the broadcast information based at least in part on the determined track. For example, the electronic device may compare a track specified by the broadcast information with the determined track.

In some embodiments, the electronic device may provide the determined track to a collision avoidance system.

Note that the broadcast information may include location information of the second electronic device that are based at least in part on GPS, such as ADS-B messages. For example, the location information may include: horizontal location or position, relative range, relative bearing, heading, relative or absolute altitude, and/or relative or absolute speed.

Moreover, the measurements may be performed multiple times to reduce or eliminate probability of another electronic device being at a same range as the electronic device.

Furthermore, the electronic device may collaboratively determine the track based at least in part on one or more additional range measurements associated with a set of one or more electronic devices, where a given additional measurement was performed using another instance of the omnidirectional antenna.

Additionally, the electronic device may provide the range measurements and/or the determined track to another aircraft, a ground control station and/or air traffic control. For example, the electronic device may provide information associated with a real-time data structure that specifies spoofed or inaccurate transponder data, such as those where there is a difference between an instance of the broadcast information and the determined track.

In some embodiments, the electronic device may determine the track when GPS is unavailable or unreliable. For example, the electronic device may receive an indication that GPS is unavailable or unreliable from or associated with a GPS receiver. In these embodiments, the electronic device may perform active surveillance using mode C or S interrogation, which provide range and altitude information associated with the second electronic device.

Note that the broadcast information may include the identifier of the second electronic device, such as an International Civil Aviation Organization (ICAO) code or designator.

Moreover, in some embodiments, the electronic device may include at least a second omnidirectional antenna. For example, the omnidirectional antenna may be disposed on or proximate to a top of the electronic device and the second omnidirectional antenna may be disposed on or proximate to a bottom of the electronic device. Note that the omnidirectional antenna and the second omnidirectional antenna may provide antenna diversity. Furthermore, the use of multiple omnidirectional antennas may provide more accurate range measurements, e.g., by performing phase-difference measurements. In some embodiments, multiple omnidirectional antennas may provide angular information (such as a bearing to the second electronic device). Alternatively, when the transmissions from multiple omnidirectional antennas are synchronized (e.g., with an adjustable or selectable relative phase delay and/or transmit power difference), the electronic device may perform beam steering.

Another embodiment provides a computer-readable storage medium for use with the electronic device. This computer-readable storage medium may include program instructions that, when executed by the electronic device, cause the electronic device to perform at least some of the aforementioned operations.

Another embodiment provides a method. This method includes at least some of the operations performed by the electronic device.

In a second group of embodiments, an electronic device is described. This electronic device includes: one or more of a variety or different types of sensors that perform measurements of an environment external to the electronic device; and one or more integrated circuits (such as one or more radios). During operation, the electronic device performs measurements of the environment using the types of sensors, where the types of sensors are different from a transponder or a transceiver. Then, the electronic device determines a track of a second electronic device in the environment based at least in part on the measurements. Next, the electronic device provides the determined track to a collision avoidance system (such as a DAA system).

Note that the types of sensors may include: an electro-optic or infrared sensor, a camera or image sensor, a light detection and ranging (LiDAR) sensor, a radio detection and ranging (RADAR) sensor, an acoustic sensor, a pressure sensor, a weather or environmental sensor (such as a temperature sensor, a wind speed sensor, a humidity sensor, etc.), an altitude sensor, and/or another type of sensor.

Moreover, determining the track may involve merging tracks associated with different measurements into a common track file.

Furthermore, the track may be determined using a pretrained model, such as a pretrained model that is trained using a supervised-learning technique.

Additionally, the electronic device may include a transponder. In some embodiments, the electronic device may include an aircraft, such as a crewed or uncrewed aircraft. For example, the electronic device may include an aircraft, such as: an airplane, a helicopter, a glider, a drone, or another type of aircraft.

Note that the collision avoidance system may include ACAS Xu or another technique associated with or defined by the Radio Technical Commission for Aeronautics (RTCA).

Another embodiment provides a computer-readable storage medium for use with the electronic device. This computer-readable storage medium may include program instructions that, when executed by the electronic device, cause the electronic device to perform at least some of the aforementioned operations.

Another embodiment provides a method. This method includes at least some of the operations performed by the electronic device.

In a third group of embodiments, an electronic device is described. This electronic device includes: an antenna; and one or more integrated circuits (such as one or more radios) that transmit and receive RF signals. During operation, the electronic device receives RF signals that convey information corresponding to an instruction (or a command) associated with air traffic control. In response, the electronic device automatically transmits second RF signals that convey second information corresponding to a response to the instruction.

Note that the instruction may include a verbal instruction. Moreover, prior to transmitting the RF signals, the electronic device may: extract the information from the RF signals; perform natural language processing (e.g., using a pretrained model, such as a neural network) on the information; and generate or select the response. Note that generating the response may include generating or voice synthesizing a verbal response to the verbal instruction (e.g., using a second pretrained model, such as a second neural network). Alternatively, selecting the response may include selecting a predetermined verbal response to the verbal instruction. Consequently, in some embodiments, the electronic device may provide an automated voice radio system for aircraft communication.

Furthermore, the response may repeat the instruction and/or may acknowledge receipt of the instruction. For example, the verbal instruction may include a squawk code, a heading, or an altitude.

Additionally, the information and the second information may include or may correspond to: automatic selection of appropriate radio frequencies for use in communication while airborne or on the ground; automatic transmission of appropriate radio calls and responses to incoming calls; automatic aircraft response through autopilot and/or ground station indications to the operator of a ground control station based at least in part on incoming radio calls and responses; and/or automatic aircraft response to adjust for current local Automatic Terminal Information Service (ATIS) or Automated Surface Observing System (ASOS) information. In some embodiment, there may be a manual override for a pilot or an operator in a ground control station to stop or modify a given automatic response.

Moreover, based at least in part on the instruction, the electronic device may subsequently selectively automatically transmit third RF signals that convey third information that indicate that the instruction has been completed. For example, the electronic device may indicate when an altitude has been changed, but may not indicate when a heading has been changed.

Furthermore, the electronic device may provide the instruction, e.g., to a pilot or an autopilot, e.g., of the electronic device. For example, the instruction may be displayed on a display or may be output into headphones of the pilot. Alternatively or additionally, the electronic device may determine one or more aircraft operations based at least in part on the instruction, and then may provide information specifying the one or more aircraft operations to the pilot or the autopilot.

Additionally, the electronic device may monitor whether the instruction has been completed. When a time interval has elapsed and the instruction has not been completed, the electronic device may provide a reminder message corresponding to the instruction, e.g., to a pilot or an autopilot, e.g., of the electronic device.

Note that the electronic device may include an aircraft, such as: an airplane, a helicopter, a glider, a drone, or another type of aircraft.

Another embodiment provides a computer-readable storage medium for use with the electronic device. This computer-readable storage medium may include program instructions that, when executed by the electronic device, cause the electronic device to perform at least some of the aforementioned operations.

Another embodiment provides a method. This method includes at least some of the operations performed by the electronic device.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in accordance with an embodiment of the present disclosure.

FIG. 2 is a flow diagram illustrating an example method for determining a track using an electronic device in FIG. 1 in accordance with an embodiment of the present disclosure.

FIG. 3 is a drawing illustrating an example of communication among electronic devices in FIG. 1 in accordance with an embodiment of the present disclosure.

FIG. 4 is a flow diagram illustrating an example method for determining a track using an electronic device in FIG. 1 in accordance with an embodiment of the present disclosure.

FIG. 5 is a drawing illustrating an example of communication among electronic devices in FIG. 1 in accordance with an embodiment of the present disclosure.

FIG. 6 is a flow diagram illustrating an example method for automatically transmitting a response to an instruction using an electronic device in FIG. 1 in accordance with an embodiment of the present disclosure.

FIG. 7 is a drawing illustrating an example of communication among electronic devices in FIG. 1 in accordance with an embodiment of the present disclosure.

FIG. 8 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In a first group of embodiments, an electronic device (such as a transponder, an aircraft that includes the transponder or an aircraft system that includes the transponder) is described. This electronic device may include: two omnidirectional antennas; and one or more integrated circuits (such as one or more radios) that transmit and receive RF signals. During operation, the electronic device may receive, using the omnidirectional antennas, broadcast information associated with a second electronic device (such as a second transponder or a second aircraft that includes the second transponder, or a repeater (e.g., an ADS-R) ground station), where the broadcast information is compatible with a regulation from a government aviation or aviation safety administration (such as the Federal Aviation Administration or the European Union Aviation Safety Agency). Then, the electronic device may validate the broadcast information using one or more of: time difference of arrival at the omnidirectional antennas; Doppler shift; or Doppler spread. Next, the electronic device may determine a track of the second electronic device based at least in part on the broadcast information. Note that the track may include one or more of: horizontal location or position, relative range, relative bearing, heading, relative or absolute altitude, and/or relative or absolute speed.

By using one or more omnidirectional antennas to transmit or receive RF signals, these communication techniques may reduce the size and weight of the electronic device (such as a transponder) relative to another electronic device that includes one or more directional antennas. For example, the electronic device may be the size of a business card and may weigh 0.25-0.33 lbs., as opposed to having a size of a shoebox and a weight of 10 lbs. Thus, the communication techniques may provide a compact, light-weight combined interrogator/transponder with a diversity omnidirectional antenna, which may be used in an ACAS-X system. Moreover, in some embodiments, the communication techniques may allow omnidirectional interrogation to be used to obtain information about the intended maneuver of another aircraft (such as the second electronic device or which may include the second electronic device), which may input to a collision avoidance system (such as a DAA system) to coordinate with the other aircraft. For example, the communication techniques may be used to: validate ADS-B based at least in part on Doppler measurements; and/or validate ADS-B based at least in part on phase detection using two or more antenna elements. Consequently, the communication techniques may reduce cost and fuel consumption, may enable new applications or use cases (such as the use of the electronic device in a drone that has limited lift and range), and may facilitate aircraft safety.

In a second group of embodiments, an electronic device (such as a transponder or an aircraft that includes the transponder) is described. This electronic device may include: one or more different varieties or types of sensors that perform measurements of an environment external to the electronic device; and one or more integrated circuits (such as one or more radios). During operation, the electronic device may perform measurements of the environment using the one or more types of sensors, where the one or more types of sensors are different from a transponder or a transceiver. Then, the electronic device may determine a track of a second electronic device (such as a second transponder or a second aircraft that includes the second transponder) in the environment based at least in part on the measurements. Next, the electronic device may provide the determined track to a collision avoidance system (such as a DAA system). In some embodiments, determining the track may involve merging tracks associated with different measurements into a common track file.

By determining the track using the measurements, these monitoring techniques may provide or use additional information that allows the track to be determined and/or improves the accuracy of otherwise determined track. For example, the monitoring techniques may provide track fusion of multiple non-cooperative sensors. These capabilities may allow the intended maneuver of another aircraft (such as the second electronic device or which may include the second electronic device), which may facilitate improved coordination with the other aircraft. Consequently, the monitoring techniques may facilitate improved aircraft safety.

In a third group of embodiments, an electronic device is described. This electronic device may include: an antenna; and one or more integrated circuits (such as one or more radios) that transmit and receive RF signals. During operation, the electronic device may receive RF signals that convey information corresponding to an instruction (or a command) associated with air traffic control. In response, the electronic device may automatically transmit second RF signals that convey second information corresponding to a response to the instruction.

By automatically transmitting the response to the instructions, these communication techniques may facilitate automation of pilot communication. Because humans are prone to errors when repeatedly performing seemingly routine tasks, the communication techniques may reduce such errors. Moreover, by freeing up the pilot to focus on aviation (instead of communication), the communication techniques may improve situational awareness and may reduce pilot fatigue. Thus, the communication techniques may provide automated air traffic control voice communication. Consequently, the communication techniques may improve aircraft safety and may improve the user experience when flying an aircraft.

In the discussion that follows, the electronic device may include or may be included in or installed on an aircraft (e.g., a transponder in the aircraft), such as a crewed aircraft (in which one or more individuals at least in part pilot of fly an aircraft) or uncrewed aircraft. For example, the electronic device may include or may be installed on an aircraft, such as: an airplane, a helicopter, a glider, a drone, an airborne taxi or another type of aircraft.

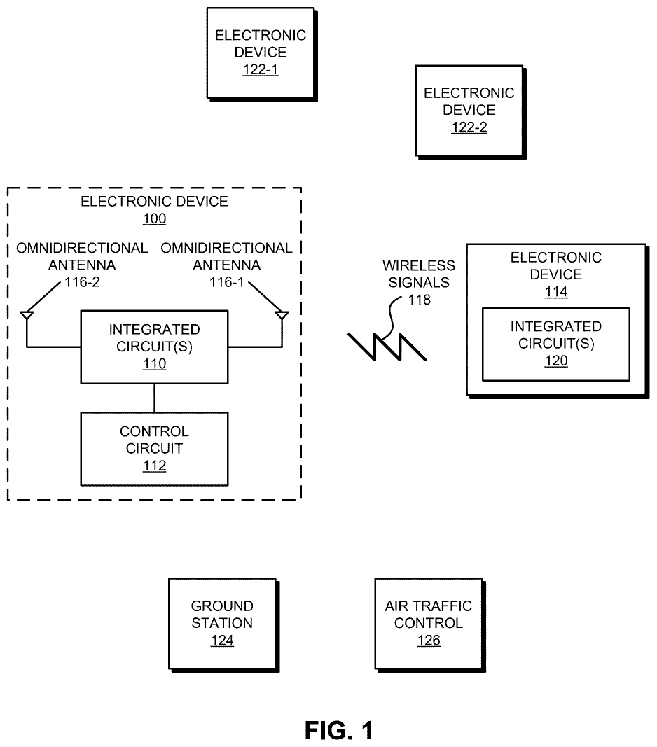

We now further describe the communication and monitoring techniques. FIG. 1 presents a block diagram illustrating an example of an electronic device 100. This electronic device may include one or more integrated circuits 110 (such as a radio circuit, which is sometimes referred to as a ‘radio’) that provide the functions or capabilities of a transponder. Notably, one or more integrated circuits 110 may transmit and receive RF signals, such as an interrogation, a transponder broadcast transmission or a transponder response from the one or more integrated circuits 110, or a second interrogation or a second transponder transmission associated with electronic device 114 (such as another aircraft, air traffic control, a ground control station, etc.) that is received by the one or more integrated circuits 110. For example, the second transponder transmission may include broadcast information. Alternatively, a received second transmission may be associated with ground control commands, a response to ground control command, etc. Moreover, electronic device 100 may include or may at least be selectively electrically coupled to at least an omnidirectional antenna 116-1 that is used for bidirectional communication, such as: transmitting the interrogation or the transponder transmission, receiving the second interrogation or the second transponder transmission, transmitting the transponder response, transmitting and/or receiving of signals associated with a collision avoidance system, a ground control command and/or a ground control response, etc. The interrogation, the transponder transmission, the second interrogation, the second transponder transmission or the transponder response may be associated with wireless signals 118.

As can be seen in FIG. 1, wireless signals 118 (represented by a jagged line) may be transmitted by the one or more integrated circuits 110 or 120. For example, the one or more integrated circuits 110 in electronic device 100 may transmit information (such as one or more packets or frames) using wireless signals 118. These wireless signals are received by the one or more integrated circuits 120 in electronic device 114. This may allow electronic device 100 to communicate information to electronic device 114 or vice versa. Note that wireless signals 118 may convey one or more packets or frames.

In the described embodiments, processing a packet or a frame in electronic device 110 or 114 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). Note that the one or more integrated circuits 110 and 120 shown in components in FIG. 1 may be the same as or different from each other.

In some embodiments, wireless communication between components in FIG. 1 uses one or more frequencies or bands of frequencies, such as: a very high frequency (VHF) range between 108 and 137 MHz, a band of frequencies associated with TCAS or ACAS (such as ACAS X), a band of frequencies associated with ADS-B, 978 MHz, 1090 MHz, 1030 MHz, a radar band of frequencies, or another frequency or band of frequencies associated with communication associated with a regulation from a government aviation or aviation safety administration. Note that the communication between electronic devices may use multi-user transmission (such as orthogonal frequency division multiple access or OFDMA) or multiple-input multiple-output (MIMO).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving wireless signals.

In some embodiments, electronic device 100 may include fewer or more components, two or more components may be combined into a single component, a second single component may be implemented using multiple components, and/or a position of at least one of the components may be changed.

As described previously, in order to reduce the size or weight of electronic device 100, in a first group of embodiments one or more omnidirectional antennas 116 may be used to determine a track of electronic device 114. Notably, electronic device 100 may receive (e.g., using omnidirectional antenna 116-1) the broadcast information associated with electronic device 114, where the broadcast information is compatible with a regulation from a government aviation or aviation safety administration (such as the Federal Aviation Administration or the European Union Aviation Safety Agency). Then, electronic device 100 may determine a track of electronic device 114 based at least in part on the broadcast information. Note that the track may include one or more of: horizontal location or position, relative range, relative bearing, heading, relative or absolute altitude, and/or relative or absolute speed.

For example, determining the track (horizontal location or position, relative range, relative bearing, heading, relative or absolute altitude, and/or relative or absolute speed) may involve measuring range (such as slant range) to electronic device 114 as a function of time (e.g., at different measurement times, such as continuously, at discrete sampling times or as-needed). Notably, the range to electronic device 114 may be measured using time-of-flight measurements by providing an interrogation signal and subsequently receiving an associated response from electronic device 114. (Thus, in some embodiments, the communication techniques may use active surveillance.) Note that the interrogation signal may be selectively transmitted to electronic device 114 with a carrier frequency of 1,030 MHz using mode S interrogation. Alternatively, the interrogation signal may be a so-called all-call interrogation with a carrier frequency of 1,030 MHz that is transmitted to any electronic device in proximity (such as wireless range) of electronic device 100, and that results in subsequent responses from any transponders that receive this interrogation signal. However, a wide variety of frequencies may be used for transmitting and/or receiving.

In some embodiments, the track may be determined in 2D, such as a plane. Alternatively, the track may be determined in 3D when an altitude or vertical position of electronic device 100 and/or electronic device 114 are available. Furthermore, in some embodiments, determining the track may involve: performing Doppler measurements of range; and correlating the range to speed and/or velocity of electronic device 114. (Note that the Doppler effect may result in an increase in carrier frequency the further a radio-frequency transmission travels. This shift in frequency can be measured and correlated to the reported position of an aircraft.)

Note that electronic device 100 may include a transponder. Consequently, the transmit RF signals and the receive RF signals may use different carrier frequencies. In some embodiments, the transmit RF signals and the receive RF signals are modulated using differential phase shift keying (DPSK) and pulse position modulation (PPM).

Moreover, electronic device 100 may validate or verify the broadcast information based at least in part on the determined track (such as an active surveillance track) and, more generally, data. For example, electronic device 100 may compare a track specified by the broadcast information with the determined track.

Furthermore, electronic device 100 may provide the determined track to a collision avoidance system, such as a DAA system. For example, the collision avoidance system may include ACAS X. In some embodiments, electronic device 114 may include a transponder in a cooperative aircraft. The broadcast information may include location information of electronic device 114 (such as horizontal location or position, relative range, relative bearing, heading, relative or absolute altitude, and/or relative or absolute speed) that are based at least in part on GPS, such as ADS-B messages.

Additionally, the measurements may be performed multiple times (such as at least 2-3×) to reduce or eliminate probability of another electronic device (such as electronic device 114) being at a same range as electronic device 100. In some embodiments, the measurements may be performed multiple times to reduce or eliminate synchronous interference associated with two or more other electronic devices at similar range that respond to active surveillance interrogations. Additionally Whisper/Shout active surveillance interrogations may be used to interrogate aircraft in a specific ranges in order to eliminate interference.

In some embodiments, electronic device 100 may collaboratively determine the track based at least in part on one or more additional range measurements associated with a set of one or more electronic devices (such as electronic devices 122, e.g., additional transponders and/or additional aircraft), where a given additional measurement was performed using another instance of data received using the omnidirectional antenna.

Note that, in some embodiments, electronic device 100 may provide the range measurements and/or the determined track to another aircraft, a ground control station 124 and/or air traffic control 126. For example, electronic device 100 may provide information associated with a real-time data structure that specifies spoofed or inaccurate transponder data, such as those where there is a difference between an instance of the broadcast information and the determined track.

Moreover, electronic device 100 may determine the track when GPS is unavailable or unreliable. For example, electronic device 100 may receive an indication that GPS is unavailable or unreliable from or associated with a GPS receiver. In these embodiments, electronic device 100 may perform active surveillance, using mode A, C or S interrogation, which provides range and/or altitude information associated with electronic device 114. Alternatively or additionally, the broadcast information may include the identifier of electronic device 114, such as an ICAO (of Montreal, Canada) code or designator.

Furthermore, in some embodiments electronic device 100 may also include at least omnidirectional antenna 116-2. Notably, electronic device 100 may include or may at least be selectively electrically coupled to omnidirectional antenna 116-1 and an omnidirectional antenna 116-2, which each may be used for bidirectional communication. For example, omnidirectional antenna 116-1 may be disposed on or proximate to a top of electronic device 100 (such as a top of an aircraft) and omnidirectional antenna 116-2 may be disposed on or proximate to a bottom of electronic device 100 (such as a bottom of an aircraft). Note that omnidirectional antennas 116 may provide antenna diversity. Additionally, the use of multiple omnidirectional antennas 116 may provide more accurate range measurements, e.g., by performing phase-difference measurements. For example, phase comparison of the electrical signals received by two or more omnidirectional antennas can be used to lookup bearing. The lookup data structure may be populated or may include phase differences associated with other tracks that have bearing available. The data structure may be applied to specific aircraft and may need to be cleared when the installation (such as the antenna cables or the antennas) was modified. The data structure may also be reset on power up and omnidirectional bearing may not be available until adequate samples are received to populate the data structure. In some embodiments, multiple omnidirectional antennas 116 (such as four omnidirectional antennas, e.g., on front and back surfaces of the top and the bottom of wings of an aircraft) may provide angular information (such as a bearing to electronic device 114). Alternatively or additionally, when the transmissions from multiple omnidirectional antennas 116 are synchronized (with an adjustable or selectable relative phase delay and/or transmit power difference), electronic device 100 may perform beam steering (such as towards a front, a side or a back direction).

In some embodiments, the one or more integrated circuits 110 may provide strong isolation between omnidirectional antenna 116-1 and omnidirectional antenna 116-2. For example, the isolation for a given omnidirectional antenna may reduce the interference from transmissions associated with the other omnidirectional antenna by at least 20 dB. Notably, the one or more integrated circuits 110 may include a PIN-diode switching network (such as a push-pull four PIN-diode or switch topology that is controlled by a control circuit 112) to provide the isolation.

While the preceding discussion illustrated the use of the communication techniques with broadcast information, more generally, the communication techniques may use one or more other types of measurements (such as radar measurements of range and/or altitude, and/or Doppler measurements) to verify or validate information specifying a track of an aircraft, e.g., as specified by ADS-B messages. Moreover, in some embodiments, the communication techniques may allow omnidirectional interrogation(s) to be used to obtain information about the intended maneuver of another aircraft, which is then input to a collision avoidance system (such as a DAA system) to coordinate with the other aircraft.

Moreover, as discussed previously, in a second group of embodiments multiple different types of sensors 122 in electronic device 100 may perform measurements of an environment external to electronic device 100. During operation, electronic device 100 may perform measurements of the environment using the types of sensors, where the types of sensors 122 are different from a transponder or a transceiver. Then, electronic device 100 may determine a track of electronic device 114 in the environment based at least in part on the measurements. Next, electronic device 100 may provide the determined track to a collision avoidance system (such as DAA system). In some embodiments, the collision avoidance system may include ACAS X or another technique defined by associated with the RTCA (of Washington DC).

Note that the types of sensors 122 may include: an electro-optic or infrared sensor, a camera or image sensor (such as CCD or a CMOS sensor), a LiDAR sensor, a RADAR sensor, an acoustic sensor, a pressure sensor, a weather or environmental sensor (such as a temperature sensor, a wind speed sensor, a humidity sensor, etc.), an altitude sensor, and/or another type of sensor.

Moreover, determining the track may involve merging tracks associated with different measurements into a common track file.

Furthermore, the track may be determined using a pretrained model, such as a pretrained model that is trained using a supervised-learning technique (such as a machine-learning model or a neural network, e.g., a convolutional neural network). For example, the supervised-learning technique may include: support vector machines, classification and regression trees, logistic regression, LASSO, logistic LASSO regression, linear regression, a Bayesian technique, and/or another (linear or nonlinear) supervised-learning technique.

Furthermore, as described previously, in a third group of embodiments electronic device 100 may automatically transmit a response to an instruction. Notably, electronic device 100 may receive RF signals that convey information corresponding to an instruction (or a command) associated with air traffic control 126. In response, electronic device 100 may automatically transmit second RF signals that convey second information corresponding to a response to the instruction.

Note that the instruction may include a verbal instruction. Moreover, prior to transmitting the RF signals, electronic device 100 may optionally: extract the information from the RF signals; perform natural language processing (e.g., using a pretrained model, such as a neural network) on the information; and generate or select the response. Note that generating the response may include generating or voice synthesizing a verbal response to the verbal instruction (e.g., using a second pretrained model, such as a second neural network, which may be the same as or different from the pretrained model). Alternatively or additionally, selecting the response may include selecting a predetermined verbal response to the verbal instruction. Thus, in some embodiments, the communication techniques may be fully electronic (without natural language processing and/or voice synthesizing), while in other embodiments the communication techniques may, at least in part, use natural language processing and/or voice synthesizing to provide situational awareness to the pilot and/or pilots of other aircraft in proximity. Consequently, in some embodiments, electronic device 100 may provide an automated voice radio system for aircraft communication.

Furthermore, the response may repeat the instruction and/or may acknowledge receipt of the instruction. For example, the verbal instruction may include a squawk code, a heading (such as ‘head 270’) or an altitude (such as ‘altitude 180’). More generally, currently, when operating under general flight operation rules, a pilot may maintain voice communication using a two-way radio with local air traffic control (such as air traffic control 126). Any manned or unmanned aircraft would benefit from the automation of these voice communication. This may include: automatic selection of appropriate radio frequencies for use in communication while airborne or on the ground; automatic transmission of appropriate radio calls and responses to incoming calls; automatic aircraft response through autopilot and/or ground station indications to the operator of a ground control station (such as ground control station 124) based at least in part on incoming radio calls and responses; and/or automatic aircraft response to adjust for current local ATIS or ASOS information. In some embodiment, there may be a manual override for a pilot or an operator in a ground control station to stop or modify a given automatic response.

Additionally, depending on the instruction, electronic device 100 may subsequently selectively automatically transmit third RF signals that convey third information that indicate that the instruction has been completed. For example, electronic device 100 may indicate when an altitude has been changed, but may not indicate when a heading has been changed.

In some embodiments, electronic device 100 may provide the instruction, e.g., to a pilot or an autopilot of electronic device 100. For example, the instruction may be displayed (e.g., on a display of the pilot or in electronic device 100) or may be output into headphones of the pilot. Alternatively or additionally, electronic device 100 may determine one or more aircraft operations based at least in part on the instruction, and then may provide information specifying the one or more aircraft operations to the pilot or the autopilot.

Moreover, electronic device 100 may monitor whether the instruction has been completed. When a time interval (such as 30 s) has elapsed and the instruction has not been completed, electronic device 100 may provide a reminder message corresponding to the instruction, e.g., to a pilot or an autopilot of electronic device 100.

While the preceding discussion illustrated the use of the communication techniques for communication with air traffic control, more generally the communication techniques may be used with a wide variety of communication, such as with: another aircraft, a ground control station, etc. Furthermore, the communication may occur in a variety of bands of frequencies.

While the preceding discussion illustrated the communication and monitoring techniques being performed by electronic device 100, in other embodiments at least some of the operations in the communication and/or monitoring techniques are performed by another electronic device, such as electronic device 114, electronic devices 122, ground control station 124, air traffic control 126, and/or a remotely located computer system with one or more computers. For example, while the third group of embodiments are illustrated as being performed by a separate electronic device (such as electronic device 100) from an autopilot, in other embodiments some or all of the operations in the third group of embodiments are performed by the autopilot.

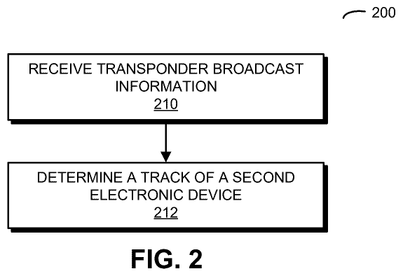

We now describe embodiments of the method. FIG. 2 presents a flow diagram illustrating an example of a method 200 for determining a track that may be performed by an electronic device, such as electronic device 100 (FIG. 1). During operation, the electronic device may receive, using one or more omnidirectional antennas, broadcast information (operation 210) associated with a second electronic device, where the broadcast information is compatible with a regulation from a government aviation or aviation safety administration. Then, the electronic device may determine the track of the second electronic device (operation 212) based at least in part on the broadcast information.

Moreover, while the preceding discussion illustrated method 200 with broadcast information, in other embodiments broadcast and/or reply information may be used.

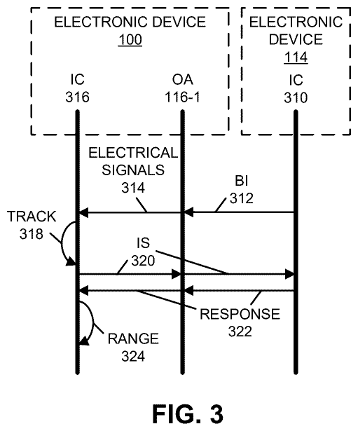

Embodiments of the communication techniques are further illustrated in FIG. 3, which presents a drawing illustrating an example of communication between electronic devices 100 and 114. Notably, interface circuit (IC) 310 in electronic device 114 may transmit broadcast information (BI) 312 to electronic device 100. After receiving wireless signals corresponding to broadcast information 312, omnidirectional antenna (OA) 116-1 in electronic device 100 may provide corresponding electrical signals 314 to interface circuit 316 in electronic device 100.

Moreover, interface circuit 316 may determine track 318 of electronic device 114) based at least in part on broadcast information 312 and, more generally, using omnidirectional antenna 116-1. For example, interface circuit 316 may determine track 318 by measuring range 324 to electronic device 114 as a function of time. In some embodiments, interface circuit 316 may measure range 324 using time-of-flight measurements by: providing an interrogation signal (IS) 320 to electronic device 114 via omnidirectional antenna 116-1; and receiving a response 322 from interface circuit 310 to interrogation signal 320. Note that interrogation signal 320 may use mode S interrogation or may use all-call interrogation.

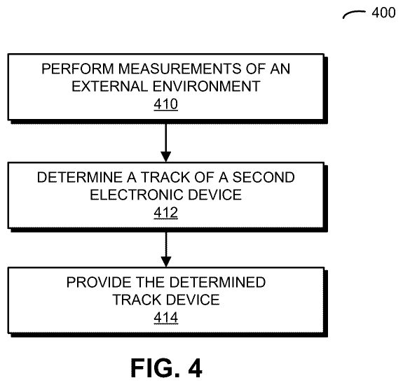

FIG. 4 presents a flow diagram illustrating an example of a method 400 for determining a track that may be performed by an electronic device, such as electronic device 100 (FIG. 1). During operation, the electronic device may perform measurements of an external environment (operation 410) of the electronic device using different types of sensors, where the types of sensors are different from a transponder or a transceiver. Then, the electronic device may determine the track of a second electronic device (operation 412) in the external environment based at least in part on the measurements. For example, the second electronic device may include a noncooperative aircraft or another object. Note that determining the track may involve merging tracks associated with different measurements into a common track file. Next, the electronic device may provide the determined track (operation 414) to a collision avoidance system (such as a DAA system).

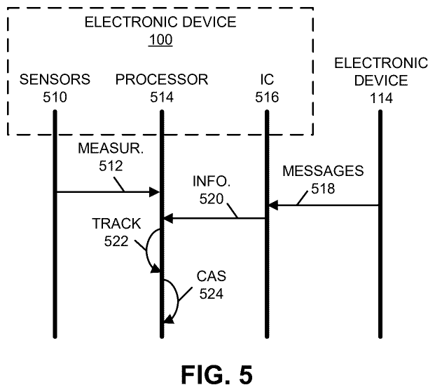

Embodiments of the communication techniques are further illustrated in FIG. 5, which presents a drawing illustrating an example of communication among components in electronic device 100. Notably, different types of sensor(s) 510 in electronic device 100 may provide measurements 512 corresponding a position, speed, altitude and/or heading of electronic device 114 to processor 514 in electronic device 100.

Moreover, interface circuit 516 in electronic device 100 (such as a transponder and/or an interrogator) may receive messages 518 from electronic device 114. These messages may include information 520 about a position, speed, altitude and/or heading of electronic device 114. Furthermore, interface circuit 516 may provide information 520 to processor 514.

Then, processor 514 may determine track 522 of electronic device 114 (such as a noncooperative aircraft or object) based at least in part on measurements 512 and/or information 520. For example, determining track 522 may involve merging tracks associated with measurements 512 and/or information 520 into a common track file. Alternatively or additionally, processor 514 may validate track 522 of a cooperative aircraft. Next, processor 514 may provide track 522 to a collision avoidance system (CAS) 524 (such as a DAA system).

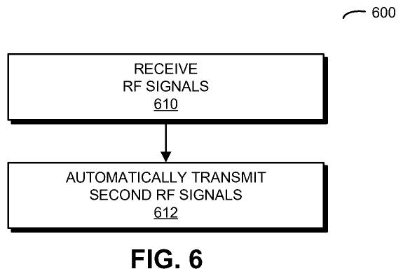

FIG. 6 presents a flow diagram illustrating an example of a method 600 for automatically transmitting a response to an instruction that may be performed by an electronic device, such as electronic device 100 (FIG. 1). During operation, the electronic device may receive RF signals (operation 610) that convey information corresponding to an instruction (or a command) associated with air traffic control. In response, the electronic device may automatically transmit second RF signals (operation 612) that convey second information corresponding to the response to the instruction.

In some embodiments, method 200 (FIG. 2), 400 (FIG. 2) and/or 600 may include additional or fewer operations. Moreover, the order of the operations may be changed, there may be different operations, two or more operations may be combined into a single operation, and/or a single operation may be divided into two or more operations.

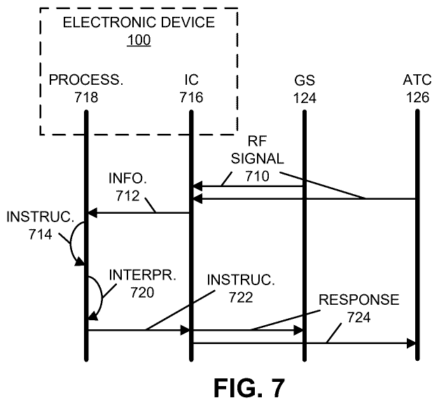

Embodiments of the communication techniques are further illustrated in FIG. 7, which presents a drawing illustrating an example of communication between electronic device 100, ground station (GS) 124 or air traffic control (ATC) 126. Notably, ground station 124 or air traffic control 126 may transmit RF signals 710 to electronic device 100 that convey information 712 corresponding to an instruction 714 (or a command) associated with air traffic control 126.

After receiving RF signals 710, an interface circuit 716 in electronic device 100 may provide information 712 to a processor 718 in electronic device 100. Then, processor 718 may extract instruction 714 based at least in part on information 712. For example, processor 718 may extract instruction 714 using a pretrained model, such as a neural network that performs natural language processing.

Moreover, processor 718 may interpret 720 instruction 714 using a second pretrained model, such as a second neural network. Next, processor 718 may instruct 722 interface circuit 716 to provide, to ground station 124 or air traffic control 126, a response 724 to instruction 714.

While FIGS. 3, 5 and 7 illustrate communication between components using unidirectional or bidirectional communication with lines having single arrows or double arrows, in general the communication in a given operation in this figure may involve unidirectional or bidirectional communication. Moreover, while FIGS. 3, 5, and 7 illustrate operations being performed sequentially or at different times, in other embodiments at least some of these operations may, at least in part, be performed concurrently or in parallel.

Note that the applicable laws for ACAS, ACAS X, ACAS-Xu, and Automatic Dependent Surveillance—Broadcast (ADS-B) may include, in the United States (e.g., from the FAA): 14 Code of Federal Regulations Part 91 (such as 91.221, 91.225 and 91.227), 121, 125, 129 and 135 (such as 135.180); Advisory Circular 90-120; and Radio Technical Commission for Aeronautics (RTCA) DO-362, 365, 366, 377, 381, 386, 387, 397, 398, 400, and 406. Moreover, the applicable laws from the European Union Aviation Safety Agency (EASA) may include: Regulation (EU) No 1332/20118; and Commission Regulation (EU) 2018/10489.

In some embodiments, the communication techniques include a Muli-Tiered ADS-B Validation (M-TAV) approach for passive validation of ADS-B data. The M-TAV may provide a passive (without RF transmissions) technique for ADS-B validation, such as during operations that require emissions control. It may also provide the benefit of RF interference reduction by eliminating the need to actively interrogate and receive replies in order to validate ADS-B. Note that the preceding embodiments and/or M-TAV may use a Reply Signal Strength (RSS) technique. This RSS technique may use ADS-B message signal strength and top/bottom antenna data (such as whether a signal was received with a top and/or a bottom antenna) to determine ADS-B validity.

In some embodiments, the preceding embodiments and/or M-TAV may use additional techniques to ensure reliable and accurate ADS-B validation, including: azimuth estimation using time, phase and/or amplitude differences between antennas when RF signals arrive or are received (such as time difference of arrival); and/or Doppler shift/spread analysis of the received RF signals. In the azimuth detection, a transponder with a diversity antenna installation may include control logic for deciding on which antenna a reply needs to be transmitted on. The control logic may be based at least in part on amplitude and timing differences of the RF signal as it is received by different antennas. A similar technique may be used to compare signal amplitude, timing and/or phase differences between antennas to estimate the azimuth of the ADS-B signal and to provide another data point for ADS-B validation. In the Doppler shift/spread analysis, note that the Doppler effect is the change in the frequency of an RF signal associated with the relative motion between the receiver and the source of the RF signal. The change in carrier frequency and/or spread may be measured and used to determine whether the source of the RF signal is relatively stationary or moving towards or away from the receiver. This information may be compared to the ADS-B information and used for the passive validation of ADS-B data.

We now describe several examples of using Time Difference of Arrival (TDOA) for validating ADS-B relative position. The variables for TDOA prediction and/or comparison may include: the coordinate frame/geometry (such as: an aircraft body-axis pointing forward (nose direction), which may be represented by x; an aircraft body-axis pointing right (starboard), which may be represented by y; and an aircraft body-axis pointing up, which may be represented by z); an antenna baseline vector from the bottom antenna to the top antenna, expressed in aircraft body coordinates [x′ y′ z′], in meters, which may be represented by b; the line-of-sight (LOS) direction; an azimuth angle (ψ) of the LOS in the aircraft body frame (in degrees or radians); and an elevation angle (ε) of the LOS (in degrees or radians), measured above the horizontal plane.

Note that

$$b = [ \begin{matrix}{b}_{x} \\ {b}_{y} \\ {b}_{z}\end{matrix} ] .$$

For an installation of a top antenna and a bottom antenna (such as omnidirectional antennas) on an aircraft (see below):

$$b = [ \begin{matrix}1 \\ 0 \\ 2\end{matrix} ] meters ,$$

where: bₓ=1 mis the forward offset, b_{y}=0 mis the right/left offset, and b_{z}=2 mis the vertical offset. Moreover, |b| is the magnitude (length) of the baseline vector:

$$\vert b \vert = \sqrt{{b}_{x}^{2} + {b}_{y}^{2} + {b}_{z}^{2}} .$$

Moreover, the LOS direction may be specified by û_{body}, a unit vector (dimensionless) in aircraft body coordinates pointing from the receiver (ownship) toward the signal source/ADS-B transmitter:

$${\hat{u}}_{body} = [ \begin{matrix}{u}_{x} \\ {u}_{y} \\ {u}_{z}\end{matrix} ] ,$$

where uₓ is the forward component of the LOS direction, u_{y} is the rightward component of the LOS direction, and u_{z} is the upward component of the LOS direction. Because it is a unit vector, it satisfies:

$${u}_{x}^{2} + {u}_{y}^{2} + {u}_{z}^{2} = 1 .$$

ψ is typically measured in the x-y plane, e.g., ψ=0°=straight ahead, and ψ=90°=directly to the right.

Moreover, ε=0°=on the horizon, ε>0°=above the horizon, and ε<0°=below the horizon. When azimuth ψ and elevation ε are used, then the unit LOS vector can be written as:

$${\hat{u}}_{body} = [ \begin{matrix}cos ε cos ψ \\ cos ε sin ψ \\ sin ε\end{matrix} ] .$$

In the TDOA analysis, ΔL_{pred} may be a predicted path-length difference (meters) between the propagation path to the top antenna and the propagation path to the bottom antenna, computed from geometry:

$$Δ {L}_{pred} = b \cdot {\hat{u}}_{body} .$$

Expanding the dot product:

$$Δ {L}_{pred} = {b}_{x} {u}_{x} + {b}_{y} {u}_{y} + {b}_{z} {u}_{z} .$$

For the stated antenna installation (b_{y}=0):

$$Δ {L}_{pred} = {b}_{x} {u}_{x} + {b}_{z} {u}_{z} = {u}_{x} + 2 {u}_{z} .$$

The speed of light c in free space (meters/second) is approximately:

$$c \approx 3 \times 1 {0}^{8} m / s .$$

The predicted time difference of arrival (seconds) between antennas, Δt_{pred}:

$$Δ {t}_{pred} = \frac{Δ {L}_{pred}}{c} .$$

Moreover, the measured time difference of arrival (seconds), Δtₘₑₐₛ, may be derived from received signal processing (e.g., correlation peak timing, matched filtering, and/or time delay estimation) between the two antenna channels. Moreover, the TDOA error or Δtₑᵣᵣ (seconds), i.e., difference between measured and predicted values:

$$Δ {t}_{e r r} = Δ {t}_{m e a s} - Δ {t}_{p r e d} .$$

The acceptance threshold (seconds), Tₜₕᵣ, used to determine whether the ADS-B implied geometry is consistent with the measured RF geometry may be:

$$\vert Δ {t}_{e r r} \vert \leq {T}_{thr} ,$$

where Tₜₕᵣ may be selected based at least in part on the expected system measurement error, noise, clock/timing uncertainty, and/or multipath.

Furthermore, the baseline/constants (used for all of the following examples) may include an antenna geometry (bottom to top), in which: a top antenna is 1 m forward of the bottom antenna, and the top antenna is 2 m above the bottom antenna. Consequently, the baseline vector in aircraft body axes is:

$$b = [ \begin{matrix}1 \\ 0 \\ 2\end{matrix} ] meters .$$

Given the speed of light c:

$$c = 3 \times 1 {0}^{8} m / s ,$$

and the predicted path-length difference:

$$Δ {L}_{p r e d} = b \cdot {\hat{u}}_{body} = {u}_{x} + 2 {u}_{z} ,$$

the predicted time difference of arrival (TDOA) may be:

$$Δ {t}_{p r e d} = \frac{Δ {L}_{p r e d}}{c}$$

and the TDOA consistency error may be:

$$Δ {t}_{e r r} = Δ {t}_{m e a s} - Δ {t}_{p r e d} .$$

Example 1: Consistent ADS-B geometry and RF TDOA (passes). The inputs may include: an ADS-B target position and ownship position/attitude may be used to compute a unit line-of-sight vector in aircraft body coordinates:

$${\hat{u}}_{body} = [ \begin{matrix}{u}_{x} \\ {u}_{y} \\ {u}_{z}\end{matrix} ] = [ \begin{matrix}0.940 \\ 0.000 \\ 0.342\end{matrix} ] ;$$

And the measured RF TDOA between antennas:

$$Δ {t}_{m e a s} = 5.40 ns$$

In the computation, the predicted path-length difference may be:

$$Δ {L}_{p r e d} = {u}_{x} + 2 {u}_{z} = 0.940 + 2 ( 0.342 ) = 0.940 + 0.684 = 1.6 \; 24 m$$

and the predicted TDOA may be:

$$Δ {t}_{p r e d} = \frac{1.624}{3 \times 1 {0}^{8}} = 5.41 ns .$$

The error may be:

$$Δ {t}_{err} = 5.40 - 5.41 = - 0 \text{.01} ns .$$

The result of this analysis may be that the measured TDOA is consistent with the ADS-B geometry (difference≈0.01 ns). Therefore, the received ADS-B position/bearing may be validated by the independent RF measurement.

Example 2: Inconsistent ADS-B geometry and RF TDOA (fails). The inputs may include: an ADS-B-derived unit line-of-sight vector in aircraft body coordinates:

$${\hat{u}}_{body} = [ \begin{matrix}0.766 \\ 0.000 \\ 0.643\end{matrix} ] ;$$

and the measured RF TDOA:

$$Δ {t}_{m e a s} = 0.80 ns .$$

In the computation, the predicted path-length difference may be:

$$Δ {L}_{p r e d} = 0.766 + 2 ( 0.643 ) = 0.766 + 1.286 = 2.0 \; 52 m$$

and the predicted TDOA may be:

$$Δ {t}_{pred} = \frac{2.052}{3 \times {10}^{8}} = 6.84 ns .$$

The error may be:

$$Δ {t}_{err} = 0.8 - 6.84 = - 6.04 ns .$$

The result of this analysis may be that the measured TDOA is not consistent with the ADS-B geometry (difference≈6.0 ns). Therefore, the received ADS-B position/bearing is flagged as inconsistent (e.g., spoofing, mis-association, or severe multipath).

Example 3: Forward versus aft discrimination (sign flip). This example shows how the sign of the TDOA prediction can be used as a strong check. The inputs may include: an ADS-B-derived unit line-of-sight vector:

$${\hat{u}}_{body} = [ \begin{matrix}- 0.866 \\ 0. \\ 0.5\end{matrix} ] ;$$

and the measured RF TDOA:

$$Δ {t}_{meas} = + 2.1 ns .$$

In the computation, the predicted path-length difference may be:

$$Δ {L}_{pred} = ( - 0.866 ) + 2 ( 0.5 ) = - 0.866 + 1. = 0.134 m .$$

and the predicted TDOA may be:

$$Δ {t}_{pred} = \frac{0.134}{3 \times {10}^{8}} = 0.45 ns .$$

The error may be:

$$Δ {t}_{err} = 2.1 - 0.45 = 1.65 ns .$$

The result of this analysis may be that, even though the predicted and measured TDOA have the same sign, the error is large enough to be inconsistent depending on threshold selection. When the measured TDOA has the opposite sign (negative), it would be an even stronger inconsistency indicator.

Note that a representative acceptance test can be stated as: Accept when:

$$\vert Δ {t}_{err} \vert \leq {T}_{thr} ,$$

where Tₜₕᵣ can be selected based on system performance, e.g.: Tthr≈0.5 ns (tight, good SNR and/or low multipath); or Tthr≈1.0-2.0 ns (looser, multipath and/or degraded conditions).

We now describe several examples of using Doppler shift/spread analysis (stationary versus moving toward/away) to validate ADS-B data or whether ADS-B data can be trusted in a particular environment. Define: f₀ as the nominal carrier frequency (Hz) (here, f₀=1.090×10⁹ Hz (1090 MHz); c is the speed of light (m/s) (c≈3.0×10⁸ m/s); vᵣ is the radial velocity of the transmitter relative to the receiver along the line-of-sight (m/s) (by convention, vᵣ>0 indicates closing or moving toward the receiver, and vᵣ<0 indicates opening or moving away); and f_{d} is the Doppler frequency shift (Hz), defined as the observed carrier frequency offset due to motion (after removing/estimating receiver oscillator offset, if applicable). For non-relativistic speeds typical of aircraft, the Doppler shift is:

$${f}_{d} = \frac{{v}_{r}}{c} {f}_{0} .$$

### Equivalently:

$${v}_{r} = \frac{c}{{f}_{0}} {f}_{d} .$$

For numerical Doppler Shift Examples (at 1090 MHz), compute the scale factor:

$$\frac{{f}_{0}}{c} = \frac{1.09 \times {10}^{9}}{3. \times {10}^{8}} \approx 3.633 Hz per ( m / s ) .$$

Then, approximately: 1 m/s radial speed≈3.63 Hz Doppler; 10 m/s≈36.3 Hz; and 100 m/s≈363 Hz.

Example 4: Stationary or near-stationary source. When the signal source is stationary relative to the receiver, vᵣ≈0, then:

$${f}_{d} \approx 0 Hz .$$

In implementation, after frequency-offset compensation, a measured Doppler magnitude |f_{d}| that is within a small tolerance (e.g., ≤10 Hz, based at least in part on measurement uncertainty) may be classified as consistent with stationary radial motion.

Example 5: Moving toward the receiver (closing). Let the radial closing speed be:

$${v}_{r} = + 50 m / s .$$

$$Then :$$

$${f}_{d} = \frac{50}{3. \times {10}^{8}} \cdot 1.09 \times {10}^{9} \approx 181.7 Hz .$$

A measured f_{d}≈+182 Hz indicates the transmitter is moving toward the receiver along the line-of-sight.

Example 6: Moving away from the receiver (opening). Let:

$${v}_{r} = - 50 m / s .$$

$$Then :$$

$${f}_{d} \approx - 181.7 Hz .$$

A measured f_{d}≈−182 Hz indicates the transmitter is moving away from the receiver along the line-of-sight.

Example 7: Higher speed (e.g., closing at 150 m/s). Let:

$${v}_{r} = + 150 m / s .$$

$$Then :$$

$${f}_{d} \approx 3 \cdot 181.7 \approx 545.1 Hz .$$

A measured f_{d}≈+545 Hz indicates a higher closing radial velocity.

We now describe a couple of examples of using Doppler spread analysis to validate ADS-B data or whether ADS-B data can be trusted in a particular environment. Define the Doppler spread (B_{d}, in Hz) as the observed spectral width (e.g., occupied bandwidth or a percentile bandwidth) of the Doppler spectrum around its center. Doppler spread can increase due to multipath, acceleration/turning, rotor/propeller modulation, and/or multiple emitters. In a first numerical example (at 1,090 MHz), in which there are low dynamics and/or low multipath: the measured Doppler is centered at f_{d}≈+182 Hz with Doppler spread B_{d}; 10 Hz. This is consistent with a single dominant line-of-sight component and relatively steady motion. Alternatively, in a second numerical example (at 1,090 MHz): the measured Doppler is centered at f_{d}+182 Hz with Doppler spread B_{d}≈80 Hz. This is consistent with significant multipath and/or time-varying radial velocity components. When the compensated Doppler estimate f_{d} is positive, the transmitter is classified as moving toward the receiver; and when f_{d} is negative, it is classified as moving away. Moreover, when |f_{d}| is below a threshold fₜₕᵣ (e.g., 10 Hz), the transmitter is classified as substantially stationary in the radial direction (within measurement uncertainty). Note that the Doppler spread B_{d} may be compared to a threshold Bₜₕᵣ to indicate multipath-rich or high-dynamics conditions.

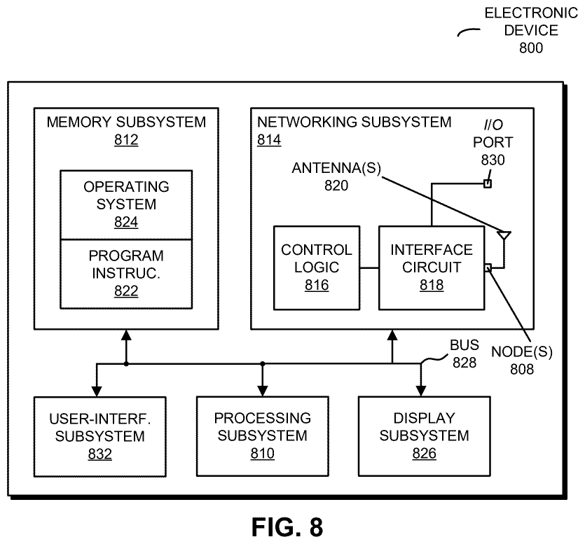

We now describe embodiments of an electronic device, which may perform at least some of the operations in the communication and monitoring techniques. FIG. 8 presents a block diagram illustrating an example of an electronic device 800 in accordance with some embodiments, such as a transponder, a transceiver, an aircraft, etc. This electronic device includes processing subsystem 810, memory subsystem 812, and networking subsystem 814. Processing subsystem 810 includes one or more devices configured to perform computational operations. For example, processing subsystem 810 can include one or more microprocessors, ASICs, microcontrollers, programmable-logic devices, one or more graphics process units (GPUs) and/or one or more digital signal processors (DSPs).

Memory subsystem 812 includes one or more devices for storing data and/or instructions for processing subsystem 810 and networking subsystem 814. For example, memory subsystem 812 can include dynamic random access memory (DRAM), static random access memory (SRAM), and/or other types of memory. In some embodiments, instructions for processing subsystem 810 in memory subsystem 812 include: one or more program modules or sets of instructions (such as program instructions 822 or operating system 824), which may be executed by processing subsystem 810. Note that the one or more computer programs may constitute a computer-program mechanism. Moreover, instructions in the various modules in memory subsystem 812 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 810.

In addition, memory subsystem 812 can include mechanisms for controlling access to the memory. In some embodiments, memory subsystem 812 includes a memory hierarchy that comprises one or more caches coupled to a memory in electronic device 800. In some of these embodiments, one or more of the caches is located in processing subsystem 810.

In some embodiments, memory subsystem 812 is coupled to one or more high-capacity mass-storage devices (not shown). For example, memory subsystem 812 can be coupled to a magnetic or optical drive, a solid-state drive, or another type of mass-storage device. In these embodiments, memory subsystem 812 can be used by electronic device 800 as fast-access storage for often-used data, while the mass-storage device is used to store less frequently used data.

Networking subsystem 814 includes one or more devices configured to couple to and communicate on a wired and/or wireless network (i.e., to perform network operations), including: control logic 816, an interface circuit 818 and one or more antennas 820 (or antenna elements) and/or input/output (I/O) port 830. (While FIG. 8 includes one or more antennas 820, in some embodiments electronic device 800 includes one or more nodes, such as nodes 808, e.g., a network node that can be coupled or connected to a network or link, or an antenna node or a pad that can be coupled to the one or more antennas 820. Thus, electronic device 800 may or may not include the one or more antennas 820.) For example, networking subsystem 814 can include a Bluetooth™ networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), an Ethernet networking system, a cable modem networking system, and/or another networking system.

Networking subsystem 814 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 800 may use the mechanisms in networking subsystem 814 for performing simple wireless communication between the electronic devices, e.g., transmitting advertising or beacon frames and/or scanning for advertising frames transmitted by other electronic devices.

Within electronic device 800, processing subsystem 810, memory subsystem 812, and networking subsystem 814 are coupled together using bus 828. Bus 828 may include an electrical, optical, and/or electro-optical connection that the subsystems can use to communicate commands and data among one another. Although only one bus 828 is shown for clarity, different embodiments can include a different number or configuration of electrical, optical, and/or electro-optical connections among the subsystems.

In some embodiments, electronic device 800 includes a display subsystem 826 for displaying information on a display, which may include a display driver and the display, such as a liquid-crystal display, a multi-touch touchscreen, etc.

Electronic device 800 can be (or can be included in) any electronic device with at least one network interface. For example, electronic device 800 can be (or can be included in): a radio, a transponder, a transceiver, a type of aircraft, a computer, a computer system, a desktop computer, a laptop computer, a subnotebook/netbook, a tablet computer, a smartphone, a cellular telephone, a smartwatch, a consumer-electronic device, a portable computing device, communication equipment, a computer network device, test equipment, and/or another electronic device.

Although specific components are used to describe electronic device 800, in alternative embodiments, different components and/or subsystems may be present in electronic device 800. For example, electronic device 800 may include one or more additional processing subsystems, memory subsystems, networking subsystems, and/or display subsystems. Additionally, one or more of the subsystems may not be present in electronic device 800. Moreover, in some embodiments, electronic device 800 may include one or more additional subsystems that are not shown in FIG. 8, such as a user-interface subsystem 832. Also, although separate subsystems are shown in FIG. 8, in some embodiments some or all of a given subsystem or component can be integrated into one or more of the other subsystems or component(s) in electronic device 800. For example, in some embodiments program instructions 822 are included in operating system 824 and/or control logic 816 is included in interface circuit 818.

Moreover, the circuits and components in electronic device 800 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 814 (or, more generally, of electronic device 800). The integrated circuit may include hardware and/or software mechanisms that are used for transmitting wireless signals from electronic device 800 and receiving signals at electronic device 800 from other electronic devices. Aside from the mechanisms herein described, radios are generally known in the art and hence are not described in detail. In general, networking subsystem 814 and/or the integrated circuit can include any number of radios. Note that the radios in multiple-radio embodiments function in a similar way to the described single-radio embodiments.

In some embodiments, networking subsystem 814 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used particular communication protocols as an illustrative example, in other embodiments a wide variety of communication protocols and, more generally, wired and/or wireless communication techniques may be used. Thus, the communication and/or monitoring techniques may be used in conjunction with a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication and/or monitoring techniques may be implemented using program instructions 822, operating system 824 (such as a driver for interface circuit 818) or in firmware in interface circuit 818. Alternatively or additionally, at least some of the operations in the communication and/or monitoring techniques may be implemented in a physical layer, such as hardware in interface circuit 818.

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the communication and/or monitoring techniques, different numerical values may be used.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
two omnidirectional antennas; and
one or more integrated circuits coupled to the omnidirectional antennas, wherein the one or more integrated circuits are configured to transmit and receive radio-frequency (RF) signals, wherein the electronic device is configured to:
receive, using the omnidirectional antennas, broadcast information associated with a second electronic device, wherein the broadcast information is compatible with a regulation from a government aviation or aviation safety administration;
validate the broadcast information using one or more of: time difference of arrival at the omnidirectional antennas; Doppler shift; or Doppler spread; and
determine a track of the second electronic device based at least in part on the broadcast information.

2. The electronic device of claim 1, wherein the track comprises one or more of: horizontal location or position, relative range, relative bearing, heading, relative or absolute altitude, or relative or absolute speed.

3. The electronic device of claim 1, wherein determining the track comprises measuring range, a bearing or both to the second electronic device as a function of time.

4. The electronic device of claim 3, wherein the range is measured using time-of-flight measurements and the measuring comprises:
providing an interrogation signal; and
receiving a response to the interrogation signal associated with the second electronic device.

5. The electronic device of claim 4, wherein the interrogation signal is selectively transmitted to the second electronic device with a carrier frequency of 1,030 MHz using mode S interrogation.

6. The electronic device of claim 4, wherein the interrogation signal comprises an all-call interrogation with a carrier frequency of 1,030 MHz that is transmitted to any electronic device in wireless range of the electronic device.

7. The electronic device of claim 3, wherein the electronic device is configured to provide, to a third electronic device, information corresponding to one or more of: the determined track, the range measurements or the bearing measurements; and
wherein the information specifies spoofed or inaccurate transponder data in which there is a difference between the broadcast information and the determined track.

8. The electronic device of claim 1, wherein the track is determined in two dimensions (2D) or three dimensions (3D) when an altitude or vertical position of the electronic device, the second electronic device or both are available.

9. The electronic device of claim 1, wherein determining the track comprises:
performing Doppler measurements of range; and
correlating the range to speed, velocity or both of the second electronic device.

10. The electronic device of claim 1, wherein the electronic device comprises a transponder, and the transmit RF signals and the receive RF signals use different carrier frequencies; and
wherein the second electronic device comprises a second transponder.

11. The electronic device of claim 1, wherein the electronic device comprises an aircraft.

12. The electronic device of claim 1, wherein the electronic device is configured to validate or verify the broadcast information based at least in part on the determined track.

13. The electronic device of claim 12, wherein the validation or verification comprises comparing a track specified by the broadcast information with the determined track.

14. The electronic device of claim 1, wherein the electronic device is configured to provide the determined track to a collision avoidance system.

15. The electronic device of claim 1, wherein the broadcast information comprises location information of the second electronic device that are based at least in part on a Global Positioning System (GPS).

16. The electronic device of claim 1, wherein the electronic device is configured to collaboratively determine the track based at least in part on one or more additional range measurements, altitude measurements or bearing measurements associated with a set of one or more electronic devices; and
wherein a given additional measurement was performed using another instance of the omnidirectional antenna.

17. The electronic device of claim 1, wherein the electronic device is configured to determine the track when a Global Positioning System (GPS) is unavailable or unreliable.

18. The electronic device of claim 1, wherein the electronic device comprises at least a second omnidirectional antenna;
wherein the omnidirectional antenna and the second omnidirectional antenna are disposed on or proximate to opposite surfaces of the electronic device; and
wherein the electronic device is configured to determine a bearing to the second electronic device using the omnidirectional antenna and the second omnidirectional antenna.

19. A non-transitory computer-readable storage medium for use in conjunction with an electronic device, the computer-readable storage medium storing program instructions, wherein, when executed by the electronic device, the program instructions cause the electronic device to perform one or more operations comprising:
receiving, using two omnidirectional antennas in the electronic device, broadcast information associated with a second electronic device, wherein the broadcast information is compatible with a regulation from a government aviation or aviation safety administration;
validating the broadcast information using one or more of: time difference of arrival at the omnidirectional antennas; Doppler shift; or Doppler spread; and
determining a track of the second electronic device based at least in part on the broadcast information.

20. A method for determining a track, comprising:
by an electronic device:
receiving, using two omnidirectional antennas in the electronic device, broadcast information associated with a second electronic device, wherein the broadcast information is compatible with a regulation from a government aviation or aviation safety administration;
validating the broadcast information using one or more of time difference of arrival at the omnidirectional antennas; Doppler shift; or Doppler spread; and
determining the track of the second electronic device based at least in part on the broadcast information.
